(19) United States
(12) Patent Application Publication
(10) Pub. No.: US 2008/0230478 A1
(43) Pub. Date: Sep. 25, 2008

(54) Regeneration Of A Chromatography Matrix

(75) Inventors: Hans J. Johansson, Uppsala (SE); Anders Ljunglof, Uppsala (SE); Per-Mikael Aberg, Uppsala (SE)

Correspondence Address: GE HEALTHCARE BIO-SCIENCES CORP.;PATENT DEPARTMENT, 800 CENTENNIAL AVENUE, PISCATAWAY, NJ, 08855, US

(73) Assignee: GE HEALTHCARE BIO-SCIENCES AB, UPPSALA (SE)

(21) Appl. No.: 11/913,101

(22) PCT Filed: May 22, 2006
(86) PCT No.: PCT/SE2006/000599

§ 371 Date: Oct. 30, 2007

(30) Foreign Application Priority Data
May 22, 2006 (SE) PCT/SE2006/000599

(51) Int. Cl. B01D 15/08; B01D 24/46

(52) U.S. Cl. 210/656; 210/791; 210/198.2

(57) ABSTRACT

The present invention relates to a process of regenerating a separation matrix, such as a chromatography matrix, comprising adsorption of at least one target molecule by contacting a mobile phase comprising at target molecule(s) with a matrix; removal of unbound material by washing the matrix; elution of target molecule(s) by contacting the matrix with an eluent; reducing regeneration by contacting said matrix with a reducing agent; alkaline regeneration by contacting the matrix with an alkaline solution; and equilibration of the matrix.

### TECHNICAL FIELD

The present invention relates to chromatography, and more specifically to a process of regenerating chromatography matrices to restore their performance. The invention also encompasses a kit for performing such regeneration, as well as a multi-step process comprising several cycles of regeneration according to the invention.

### BACKGROUND

The term chromatography embraces a family of closely related separation methods based on two mutually immiscible phases brought into contact, wherein one phase is stationary and the other one is mobile. One area wherein chromatography has recently become of great interest is in the biotechnological field, such as for large-scale economic production of novel drugs and diagnostics. Generally, proteins are produced by cell culture, either intracellularly or secreted into the surrounding medium. Since the cell lines used are living organisms, they must be fed with a complex growth medium, containing sugars, amino acids, growth factors, etc. Separation of the desired protein from the mixture of compounds fed to the cells and from other cellular components to a sufficient purity, e.g. for use as a human therapeutic, poses a formidable challenge.

Conventionally, cells and/or cell debris has been removed by filtration. Once a clarified solution containing the protein of interest has been obtained, its separation from the other components of the solution is usually performed using a combination of different chromatographic techniques. These techniques separate mixtures of proteins on the basis of their charge, degree of hydrophobicity, affinity properties, size etc. Several different chromatography mattices are available for each of these techniques, allowing tailoring of the purification scheme to the particular protein involved.

As in all process technology, an important aim is to keep the production costs low. Thus, in order to reduce the number of steps required to obtain a product from a cell culture or lysate, improved chromatographic techniques have been presented. Similarly, chromatography matrices are when possible reused. However, since each use of a chromatography matrix will leave certain traces of the operation just performed, many different cleaning protocols are available for restoring the matrix into its original form. Commonly known materials that need to be removed are e.g. non-eluted proteins and protein aggregates. Another important concern within the pharmaceutical industry is the presence of potentially hazardous materials, such as virus, endotoxins etc, which originates from the cell culture and which need to be removed to avoid cross-contamination between batches.

The most commonly used cleaning is a simple wash with buffer, such as the equilibration buffer. Such washing can only be used to restore the matrix a limited number of times. For a more efficient cleaning, treatments with acid and/or base are frequently used, each removing acid and base-sensitive contaminants respectively. In order to even more efficiently restore the matrix, an alkaline protocol known as Cleaning In Place (CIP) is commonly used with many matrices. The standard CIP involves treatment of the matrix with 1M NaOH, pH 14. Such harsh treatment will efficiently remove undesired fouling such as by protein aggregates and the like, but may on the other hand impair some chromatography matrices. For example, many affinity matrices, wherein the ligands are proteins or proteinaceous, cannot withstand standard CIP, at least not while maintaining their original properties. For example, one of the most commonly used affinity chromatography matrices for purification of antibodies comprises Protein A ligands, but such matrices needs to be cleaned under milder conditions than conventional CIP in order to maintain selectivity and binding capacity. In this context, it is understood that the cleaning is closely related to the lifetime of the chromatography matrix. For example, a sensitive matrix may be cleaned with standard CIP, if a reduced performance is acceptable. The performance of column packed with a chromatography matrix is easily verified using well known methods.

Brorson et al (Kurt Brorson, Janice Brown, Elizabeth Hamilton, Kathryn E. Stein in Journal of Chromatography A, 989 (2003) 155-163: Identification of protein A media performance attributes that can be monitored as surrogates for retrovirus clearance during extended re-use”) describes how Protein A media can be re-used after cleaning with 6M urea or 6 M guanidine hydrochloride, which are known as milder cleaning buffers than sodium hydroxide. It is concluded that column performance was stable even after more than 300 cycles. However, use of urea involves certain drawback. For once, it is a relatively costly chemical at present. Secondly, due to its fertilising effect, it cannot be readily disposed of without taking certain precautions to obey with legislation.

Thus, there is still a need in this field of alternative cleaning protocols for chromatography matrices, especially for use with more labile materials.

### BRIEF DESCRIPTION OF THE PRESENT INVENTION

The present invention relates to problems associated with the re-use of separation matrices, preferably chromatography matrices. Illustrative such problems are fouling of packed chromatography matrices and the building up of back pressure during operation. thus, one aspect of the present invention is a process of regenerating a separation matrix. This may be achieved using a protocol comprising at least one reducing regeneration, as defined in the appended claims.

A specific aspect of the invention is a process of regenerating a chromatography matrix which comprises labile ligands and/or support materials.

Another aspect of the present invention is the use of a regenerated chromatography matrix in the purification of target molecules, such as proteins.

Other aspects and advantages of the present invention will appear from the detailed description that follows.

### BRIEF DESCRIPTION OF DRAWINGS

FIG. 1 shows a comparison of selected chromatograms during lifetime study including reducing regeneration according to the invention.

FIG. 2 shows the host cell protein concentration in the elution peaks from an extended cleaning protocol including reducing regeneration according to the invention.

FIG. 3 shows the yield (%) versus cycle number from an extended cleaning protocol according to the invention.

FIG. 4 shows the peak broadening of elution peaks obtained after reducing regeneration according to the invention (triangles, lower curve) and without wash with reducing agent (filled circles, upper curve).

FIG. 5 shows the leakage of Protein A during a control experiment as described in the Experimental part.

### DEFINITIONS

The term “regeneration” of a chromatography matrix means herein to a process which substantially restores the matrix to its original strength or properties.

The term “chromatography matrix” means herein a stationary phase for use in chromatography, also known as a resin. A chromatography matrix is commonly comprised of a porous or non-porous solid support, to which a plurality of ligands have been coupled, directly or via spacers or extenders.

The term “ligand” is used herein as conventionally used within the field of chromatography, i.e. for a group or a compound, which comprises at least one functional group.

The term “alkaline-labile” means herein sensitivity to alkaline concentrations corresponding to pH values in the region of 10-14.

The term “proteinaceous ligands” means herein ligands that comprise proteins and/or protein-like molecules such as peptides.

The term “eluent” means herein a liquid capable of releasing target molecules from a chromatography matrix. The releasing action may e.g. be provided by the pH and/or the conductivity of the eluent.

The term “target molecules” is used herein for any specific molecule or kind of molecule that adsorbs to the chromatography matrix in question, and embraces compounds and cells as well as actual molecules.

The term “break-through capacity” is defined as the amount of target molecules than can be applied to a chromatography matrix, normally packed in a column, before break-through of target molecules in the effluent. The term Q_{B10%}, is commonly used, and refers to the point when the effluent concentration reaches 10% of the initial sample concentration.

### DETAILED DESCRIPTION OF THE INVENTION

In a first aspect, the present invention relates to a process of regenerating a separation matrix, comprising
(a) providing a matrix from which an adsorbed sample has been eluted;
(b) reducing regeneration by contacting said matrix with a reducing agent;
(c) alkaline regeneration by contacting the matrix with an alkaline solution;
(d) equilibration of the matrix;
   wherein the regeneration steps are carried out in any order of sequence. In one embodiment, the order of steps is the above.

In the present process, the separation matrix is advantageously a chromatography matrix, which has been used in a chromatography process. In one embodiment, a sample from which one or more target molecules are to be isolated is combined with a suitable buffer to form a mobile phase, which is subsequently contacted with the matrix during a suitable period of time for said target(s) to adsorb. In an alternative embodiment, the sample comprises buffer and can be contacted with the matrix as such. As is well known, conventional chromatography matrices commonly retain a certain amount of unbound materials, which are easily removed by washing with a suitable liquid, preferably by washing with a buffer. After having removed such unbound materials, elution is commonly performed by adding an eluent, which is capable of releasing the adsorbed target molecule(s) from the matrix.

Thus, in one embodiment, the present process of regenerating a separation matrix comprises
(a) adsorption of at least one target molecule by contacting a mobile phase comprising target molecule(s) with a matrix;
(b) removal of unbound material by washing the matrix;
(c) elution of target molecule(s) by contacting the matrix with eluent;
(d) reducing regeneration by contacting said matrix with a reducing agent;
(e) alkaline regeneration by contacting the matrix with an alkaline solution; and
(f) equilibration of the matrix;
   wherein the regeneration steps are carried out in any order of sequence. In one embodiment, the order of steps is the above. As discussed above, the separation matrix is advantageously a chromatography matrix.

As the skilled person in this field will easily realise, each added solution, such as eluent, solution comprising the reducing agent, buffers etc are advantageously withdrawn from the matrix before the next one is added. In the most advantageous embodiment of the process, the chromatography matrix is present in a chromatography column, such as an axial or radial chromatography column. In one embodiment, the liquids are added and withdrawn as in batch adsorption chromatography. In an alternative embodiment, the liquids are passed across the column by pumping; by gravity; or by use of a pressure differential.

In an advantageous embodiment, the present process comprises acidic regeneration by contacting the chromatography matrix with an acidic solution at any time after elution but before equilibration of the chromatography matrix. In a specific embodiment, the acidic regeneration is carried out after the reducing regeneration.

As the skilled person in this field will recognize, adding a reducing agent in a chromatographic process may entail the risk of retained reducing agent in the matrix, which could potentially harm or contaminate the target molecule(s). However, by performing at least one of acidic and alkaline regeneration subsequent to the addition of reducing agent, such risk is minimized or even eliminated. Thus, in one embodiment, the acidic and alkaline regenerations are carried out subsequent to the reducing regeneration. In a specific embodiment, the order of steps after elution is reducing regeneration; acidic regeneration; alkaline regeneration; and equilibration.

The present process may be utilised with any kind of chromatography matrix, provided the support and the ligands are capable of withstanding the reducing regeneration. Thus, the process is applicable to regeneration of matrices for ion exchange, such as cation exchange and anion exchange; hydrophobic interaction chromatography (HIC) matrices; immobilised metal affinity chromatography (IMAC) matrices; and affinity matrices, such as with proteinaceous ligands.

However, chromatography matrix comprising bonds or groups that are susceptible to reduction should be avoided. For example, some bonds such as disulfide bonds which will be readily reduced should be avoided. In one embodiment of the process, the chromatography matrix comprises proteinaceous ligands substantially devoid of reducible bonds, such as disulfide bonds. In this context, “substantially devoid of” means that the number of disulfide bonds is sufficiently low for the ligand not to be impaired by the reducing regeneration. In a specific embodiment, the ligands of the chromatography matrix do not comprise any such reducible bonds.

The present invention is especially advantageously used for regenerating a chromatography matrix which is sensible to the conventionally used regeneration protocol using harsh alkaline conditions, commonly using 1M NaOH. Thus, in an advantageous embodiment, the ligands are alkaline-labile. As is well known, due to their composition, proteinaceous ligands are usually sensitive to harsh alkaline conditions, such as 1M NaOH. Thus, in an advantageous embodiment, the proteinaceous ligands comprise Protein A. As is well known, Protein A, which presents a peptidic backbone and no disulfide bonds, is a commonly used protein ligand due to its superior specificity to antibodies. Protein A separation matrices are commercially available, such as the product line MabSelect™ (GE Healthcare, Uppsala, Sweden).

As the skilled person will readily recognize, the discussion above regarding ligands susceptible to reduction applies equally to the support material. The above-discussed ligands may be coupled to any well known kind of porous or non-porous support, which may be in the form of particles, such as essentially spherical particles, a monolith, filter, membrane, surface, capillaries, etc. In one embodiment, the support is prepared from a native polymer, such as cross-linked carbohydrate material, such as agarose, agar, cellulose, dextran, chitosan, carrageenan, gellan, alginate etc. To obtain high adsorption capacities, the support is preferably porous, and ligands are then coupled to the external surfaces as well as to the pore surfaces. Such native polymer supports are easily prepared according to standard methods, such as inverse suspension gelation (S Hjertén: Biochim Biophys Acta 79(2), 393-398 (1964).

Alternatively, the support is prepared from a synthetic polymer, such as cross-linked synthetic polymers, e.g. styrene or styrene derivatives, divinylbenzene, acrylamides, acrylate esters, methacrylate esters, vinyl esters, vinyl amides etc. Such synthetic polymers are easily produced according to standard methods; see e.g. “Styrene based polymer supports developed by suspension polymerization” (R Arshady: Chimica e L'Industria 70(9), 70-75 (1988)).

In yet an alternative embodiment, the support of the chromatography matrix which is regenerated according to the invention is prepared from an inorganic material, such as glass or silica. In a specific embodiment, the support is comprised of controlled pore glass (CPG) particles.

Immobilising ligands to anyone of the above-discussed supports is also easily performed by the skilled person in this field following well-known methods; see e.g. Immobilized Affinity Ligand Techniques, Hermanson et al, Greg T. Hermanson, A. Krishna Mallia and Paul K. Smith, Academic Press, INC, 1992.

However, chromatography matrices suitable for regeneration according to the present invention are also readily available from commercial sources, such as the Sepharose™ and Source™ series (GE Healthcare Bio-Sciences, Uppsala, Sweden), which include ion exchangers and hydrophobic interaction chromatography matrices. In an advantageous embodiment, the chromatography matrix is MabSelect™ or MabSelect Xtra™ (GE Healthcare Bio-Sciences, Uppsala, Sweden).

In an advantageous embodiment, the adsorption of target molecule(s) is advantageously carried out to a chromatography matrix equilibrated with a buffer. Such buffers are readily available from commercial sources and easily selected by the skilled person in this field depending on the nature of the chromatography matrix and target molecule(s).

In an advantageous embodiment, the washing of the chromatography matrix to which target molecule(s) have been adsorbed is carried out by contacting the chromatography matrix with a buffer. The buffer may be any suitable buffer, such as the same kind used for equilibration.

In an advantageous embodiment, the elution is carried out by a stepwise or continuous pH gradient. Such gradients, and useful methods for providing them e.g. by buffer blending, are well known in this field. The eluent is easily selected by the skilled person in this field depending on the nature of the chromatography matrix and target molecule(s).

The reducing regeneration may be performed using any suitable reducing agent, preferably in the form of a solution, such as DTE, DTT, mercaptoethanol, L-cysteine, and thioglycerol, which are all readily commercially available. In one embodiment, the reducing agent comprises one or more thiols. In a specific embodiment, the reducing agent comprises thioglycerol. The optimal pH for reducing regeneration will be dependent on the reducing agent selected, and will commonly be in a range of 8-8.5. Thus, in one embodiment, the reducing regeneration is carried out at alkaline pH.

The acidic regeneration may be performed using any suitable acid, such as acetic acid. In one embodiment of the present process, the acidic regeneration is carried out at pH below 3. As the skilled person in this field will recognize, to obtain the most advantageous acidic regeneration, some processes may require certain conductivity. Thus, in one embodiment, the acidic regeneration is carried out with a solution comprising salt. Illustrative salts are e.g. sodium sulphate (Na₂SO₄) and sodium chloride (NaCl).

The alkaline regeneration may be performed using any suitable alkaline agent, such as sodium hydroxide of a suitable concentration. In one embodiment of the present process, the alkaline regeneration is carried out at pH in the range of 10-14, such as 11-13. In one embodiment, the pH is 11-12. In another embodiment, the pH is 12-13. As the skilled person in this field will recognize, to obtain the most advantageous alkaline regeneration, some processes may require certain conductivity. Thus, in one embodiment, the alkaline regeneration is carried out with a solution comprising salt. Illustrative salts are e.g. as exemplified above in the context of the acidic regeneration.

The present invention also encompasses the chromatography matrix regenerated using the process according to the invention. Consequently, in a further aspect, the invention relates to the use of a regenerated chromatography matrix according to the invention for the isolation, purification and/or separation of antibodies. Thus, the present chromatography matrix is useful to recover monoclonal or polyclonal antibodies, such as antibodies originating from mammalian hosts, such as mice, rodents, primates and humans, or anti-bodies originating from cultured cells such as hybridomas. In a specific embodiment, the antibodies recovered are immunoglobulin G (IgG). In the present context, it is to be understood that the term “antibodies” also includes antibody fragments and any fusion protein that comprises an antibody or an antibody fragment. The antibodies recovered according to the present invention are useful as drugs, such as personalised medicine which comprise an active ingredient designed for a specific individual, or in conventional medicine. The antibodies isolated according to the invention are also useful in research and in the diagnostic field. Alternatively, the regenerated chromatography matrix of the invention may be used to remove undesired molecules, such as antibodies, from a desired liquid.

In a further aspect, the invention relates to a kit for regenerating a chromatography matrix, which kit comprises, in separate compartments, at least one reducing agent; at least one alkaline buffer; and written instructions for its use. In one embodiment, the kit comprises at least one acidic buffer. In another embodiment of the present kit, the reducing agent is an aqueous stable solution containing a reducing agent, such as thioglycerol. Suitable buffers and reducing agents may be as discussed above. In a specific embodiment, the present kit comprises, in separate compartments, a packed chromatography column; at least one reducing agent; at least one alkaline buffer; and written instructions for its use.

In a final aspect, the invention relates to a method for isolating at least one target molecule, which method comprises
(a) adsorption of target molecules by contacting a mobile phase comprising target molecule(s) with a separation matrix;
(b) preferably before the break-through capacity is reached in step (a), removal of unbound material by washing of the matrix;
(c) elution of target molecule(s) by contacting the matrix with an eluent;
(d) after re-equilibration of the matrix; repeating steps (a)-(c);
(d) reducing regeneration by contacting said matrix with a reducing agent;
(e) alkaline regeneration by contacting the matrix with an alkaline solution;
(f) equilibration of the matrix; and, optionally, repeating steps (a)-(f);
   wherein the regeneration steps are carried out in any order of sequence. In one embodiment, the order of steps is the above. In an advantageous embodiment, the separation matrix is a chromatography matrix, as discussed above.

In an advantageous embodiment, the method comprising acidic regeneration by contacting the chromatography matrix with an acidic solution at any time after elution but before equilibration of the chromatography matrix. The details described above in the context of the regeneration process according to the invention may also apply to the present aspect of the invention, such as buffers, reducing agents etc.

In one embodiment of the method, steps (a)-(c) are repeated 2-5 times, optionally including (d). This embodiment is especially useful to purify a target molecule from a large feed of fermentation broth, which requires more than one run on the chromatography matrix to recover all target molecules.

In an advantageous embodiment, steps (a)-(c) are carried out any number of times, such as 1-5 times, followed by the regeneration protocol according to the invention in any one of the above-discussed embodiments. The equilibration will be included if required. The regenerated chromatography matrix may then be used again e.g. in accordance with steps (a)-(c), such as 1-5 times, followed by a second regeneration protocol. As the skilled person in this field will realise, the process may be adapted in any way suitable for the specific purpose and target, including one, two or more regeneration protocols in between which the actual chromatography procedure is carried out.

Thus, in a specific embodiment, the whole method, i.e. steps (a) to (f) are repeated 2-500 times, such as 2-400, advantageously 2-300 and more advantageously 2-200 times. In a specific embodiment, the whole method is repeated 2-200 times. As the person skilled in this field will understand, steps (a)-(c) may be repeated a number of times, such as 2, 3, 4, 5 or more times, without the more thorough regeneration of the subsequent steps. How often the regeneration of the invention, starting with step (d), is required will depend on the kind of separation matrix, target molecule and the level of impurities as well as on the required performance. Thus, the protocol will easily be optimised for each specific case by the skilled person in this field. As discussed above in the Background section, running the regeneration is especially useful when changing from one feed to another, or in case the fouling of the matrix impairs its performance to a non-acceptable extent.

In the most advantageous embodiment, the target molecules are proteins, such as antibodies, for example monoclonal antibodies. The use of the recovered antibodies is as described above. In an advantageous embodiment, the chromatography matrix comprises proteinaceous ligands, preferably protein A ligands.

### DETAILED DESCRIPTION OF THE DRAWINGS

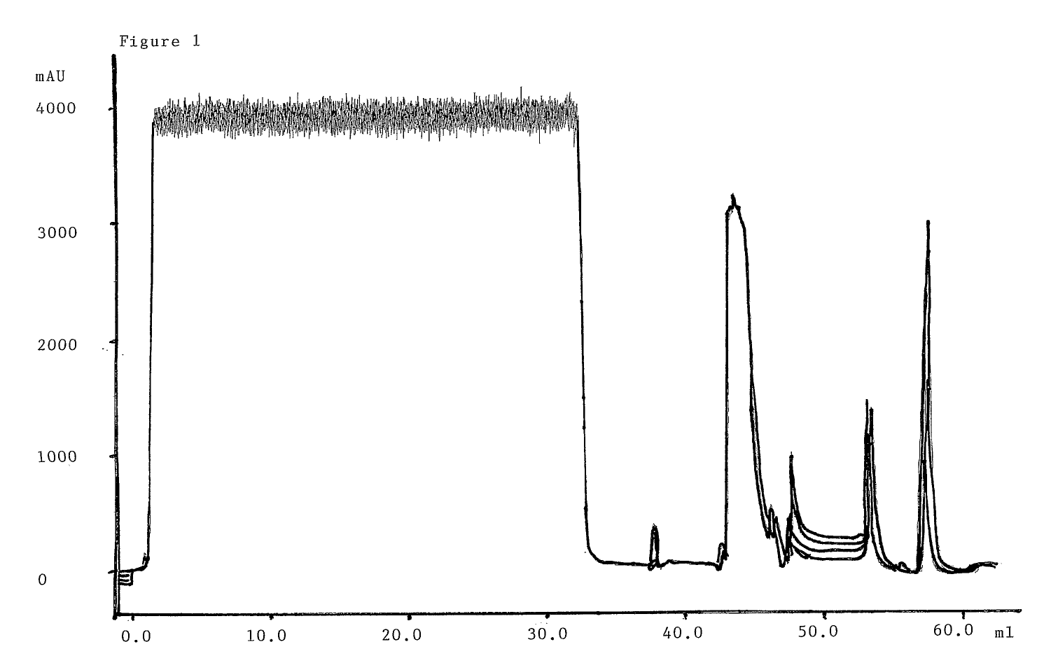

FIG. 1 shows a comparison of selected chromatograms during lifetime study including reducing regeneration according to the invention, as described in example 1 below. More specifically, cycle 6 (shown in blue), cycle 21 (shown in red), cycle 40 (shown in brown) and cycle 60 (shown in green) illustrates how little the separation matrix is affected by repeated cleaning protocols according to the invention.

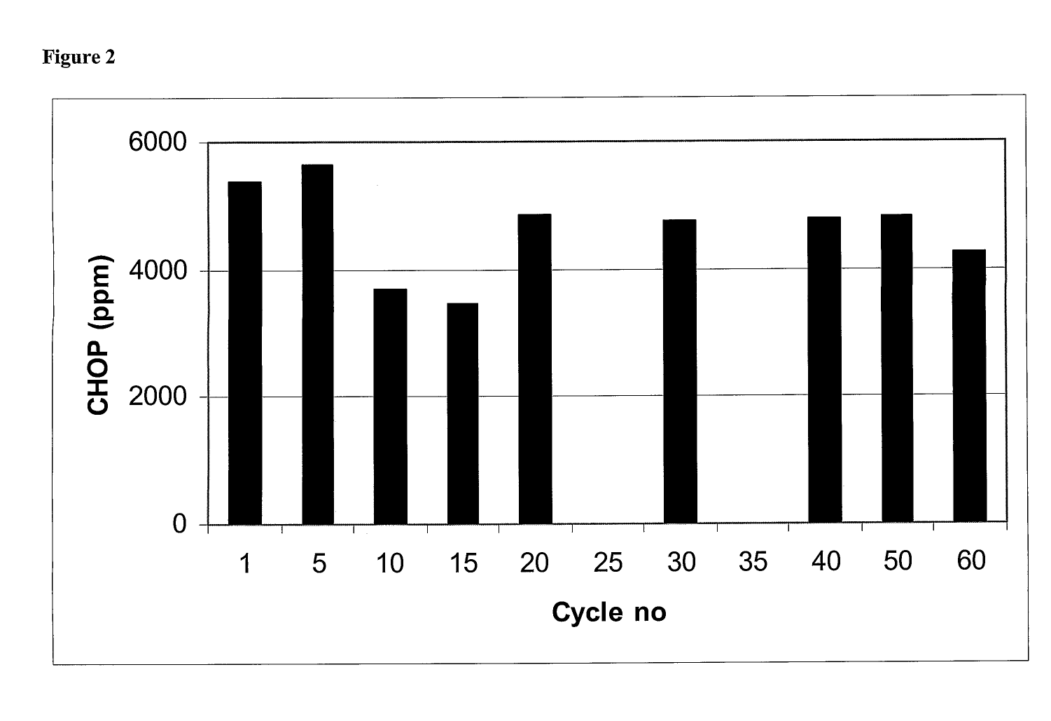

FIG. 2 shows the host cell protein concentration in the elution peaks from an extended cleaning protocol including reducing regeneration according to the invention. The reducing agent is 1-thioglycerol, and the concentration of host cell protein (CHOP) is in ppm. As appears from FIG. 2, the concentration of host cell protein is essentially unchanged, which means that the separation matrix is still capable of removing undesired components even after a large number of regeneration cycles.

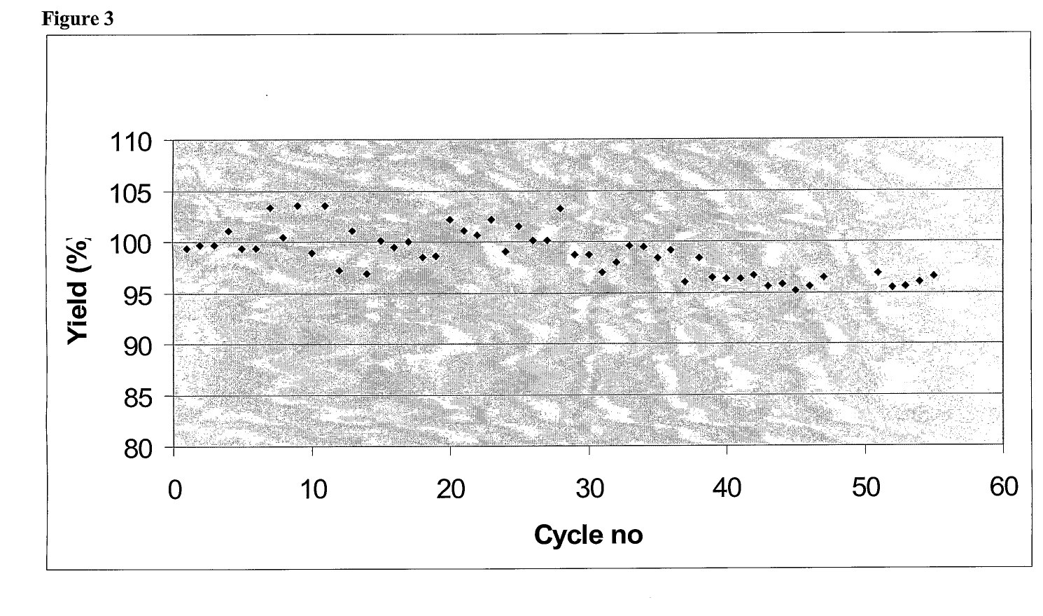

FIG. 3 shows the yield (%) versus cycle number from an extended cleaning protocol according to the invention, wherein the reducing agent is 1-thioglycerol. As expected from a well functioning cleaning protocol, the yield remains substantially unaltered.

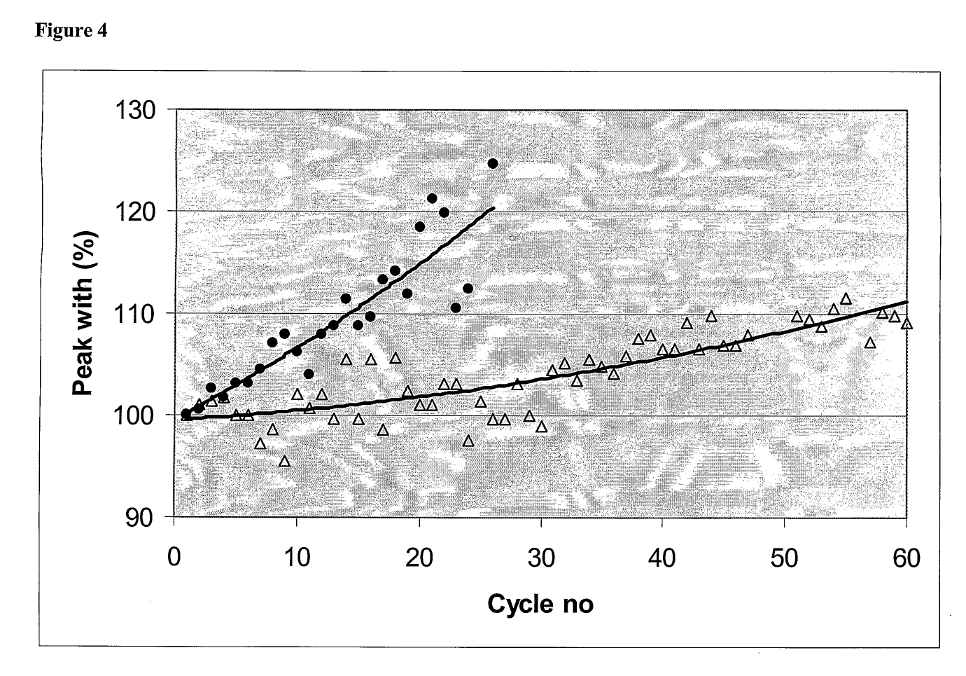

FIG. 4 shows the peak broadening of elution peaks obtained after reducing regeneration according to the invention (triangles, lower curve) as described in example 3 below; and a conventional cleaning protocol without wash with reducing agent (filled circles, upper curve). As appears from FIG. 4, the conventional cleaning protocol leads to peak broadening much sooner than the protocol according to the invention.

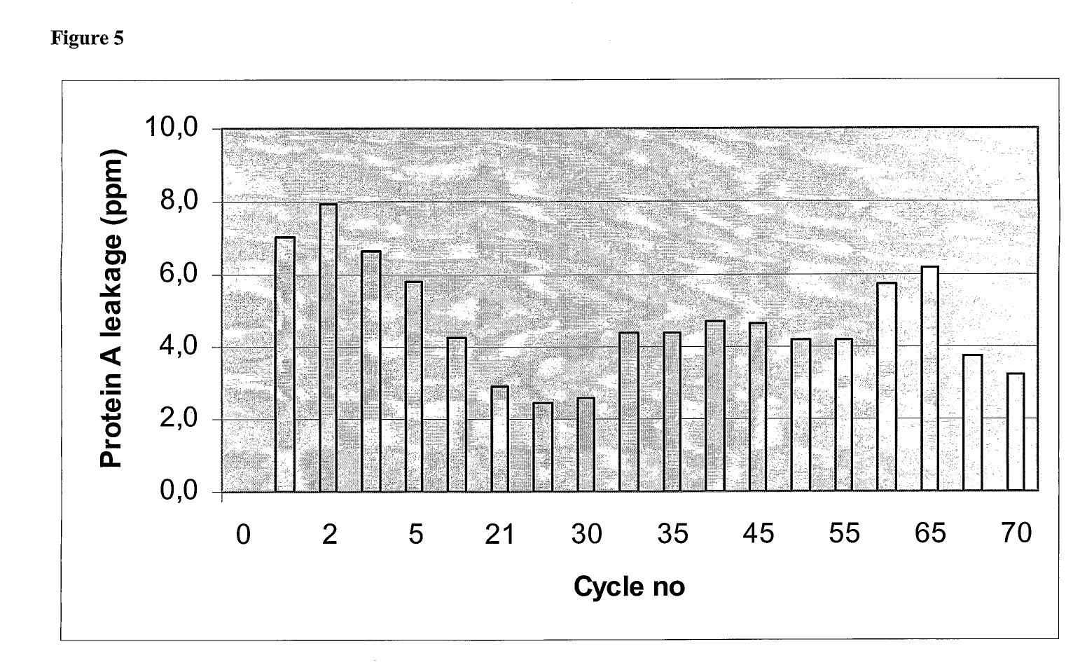

FIG. 5 shows the leakage of Protein A from an affinity matrix during a control experiment as described in the Experimental part below. As appears from FIG. 5, the leakage does not present any substantial increase even after a large number of cycles, which means that the binding of Protein A ligands to the separation matrix is not affected to any substantial degree by the cleaning protocol according to the invention.

### EXPERIMENTAL PART

The following examples are provided for illustrative purposes only, and should not in any way be construed as limiting the scope of the invention as defined by the appended claims.

Materials/Investigated Units

Instruments

| | |
|---|---|
| Chromatography system | ÄKTA ™ Explorer 10, HJ E-10, with |
| | UNICORN v. 4.11 |
| Spectrophotometer | Ultrospec 3000pro, no 839 |

Columns

HR 5/5, GE Healthcare Bio-Sciences

Chemicals/Other

| | |
|---|---|
| Acetic acid, Merck, cat. no. 1.00063, p.a. | Benzyl alcohol, Merck, |
| | cat. no. 1.09626, p.a. |
| HCl, Merck, cat. no. 1.00317, p.a. | Na-citrate, Merck, |
| | cat. no. 1.06448, p.a. |
| NaCl, Merck, cat. no. 1.06404, p.a. | NaN₃, BDH, cat. no. |
| | 103692K, Merck cat. no. |
| | 6688 |
| NaOH, Merck, cat. no. 1.06469, p.a. | Na₂SO₄, Merck, |
| | cat. no. 1.06649, p.a. |
| Tris, Merck, cat. no. 1.08382, p.a. | |
| 1-thioglycerol 90, from GE Healthcare | |
| Bio-Sciences (raw material supply) 30-2507-00 | |
| KCl, Merck, cat no 4936.1000 | |
| EDTA, anhydrous, SIGMA | |
| Water: MilliQ | |
| Filters: 1.2 μm, 0.45 μm, 0.22 μm, | |
| Millipore | |

Resins

MabSelecXtra™

Buffers

| | |
|---|---|
| Equilibration buffer: | 25 mM Tris, 0.15 M NaCl, pH 7.4 |
| Elution buffer: | 100 mM acetic acid, pH 3.6 |
| Neutralisation buffer: | 1 M Tris pH 9.0 (collected fractions in |
| | test tubes) |
| Acidic regeneration buffer. | 1 M acetic acid, 50 mM Na₂SO₄ |
| Wash (reducing agent) | 100 mM 1-thioglycerol, 25 mM TRIS, |
| | 0.15 M NaCl, 25 mM KCl, 1 mM EDTA |
| | pH 8.5 |
| Alkaline regeneration | 50 mM NaOH, 0.5 M Na₂SO₄ |
| solution: | |
| Storage buffer: | 2% Benzyl alcohol, 50 mM Na-citrate, |
| | pH 5.0 |

Samples

In this example, feed containing fusion protein expressed in Chinese hamster ovary (CHO) cells was used. The expression of protein was carried out following well known methods. The feed contained 0.48 mg/mL of the fusion protein.

Polyclonal human IgG, Gammanorm, was obtained from Octapharma AB.

Analyses

The protein A and host cell protein content (CHOP) was determined in the eluate pools of selected cycles by ELISA.

### Example 1

### Column Packing

HR 5/5 column were filled with 4 M NaCl. A packing tube (HR 16) was connected, and was filled with 20% gel slurry in ˜0.2 M NaCl. Packing was then performed in Milli Q water at 3 ml/min for 3 min. The packing tube was then disconnected, and a top adaptor was lowered towards the gel surface. After additional packing at 3 ml/min, the adaptor was adjusted 1 mm into the bed. Packing was then continued at 1 ml/min for 20 minutes. Packing performance (i.e. plate number and asymmetry) was evaluated by injection of 100 μl 2% acetone at a flow rate of 0.35 mL/min. The acceptance criteria for the column packing were an asymmetry between 0.8-1.33 and number of theoretical plates >2000 N/m.

### Example 2

### Purification Protocol According to the Invention

The method is summarised in table 1 below. The buffer compositions are found in section Materials/Investigated units above. The UV was detected at 280 nm.

TABLE 1
A cleaning protocol according to the invention

| Step | Amount | | Flow (cm/h) | Buffer | Comment |
|---|---|---|---|---|---|
| Equilibration | 6 | CV | 300 | Equilibration | |
| Load | 15-18 | mg/ml* | 206 | CHO supernatant | 6 min residence time, load to 15-18 mg/mL media |
| Wash | 6 | CV | 300 | Equilibration | |
| Wash | 5 | CV | 300 | 25 mM TRIS pH 8.0 | |
| Elution | varied | | 300 | Elution | Start/stop collect at 300 mAU |
| Reducing reg | 6 | CV** | 300 | Reducing buffer | 100 mM 1-thioglycerol*** |
| Acid regener | 3 | CV | 206 | Strip | |
| Wash | 1 | CV | 206 | Equilibration | |
| Basic regene | 3 | CV | 103 | CIP solution | 12 min residence time |
| Wash | 0.5 | CV | 103 | Equilibration | 12 min residence time, performed every two cycles |
| Storage | 3 | CV | 103 | Storage | 12 min residence time, performed every two cycles |

*The sample load was decreased to 15 mg/ml, i.e. 82% of Q_{B,10%}. In addition a control experiment was performed with human IgG in equilibration buffer as described below.
**A control experiment was performed with 0 CV, i.e. without the reducing regeneration according to the invention.
***New 1-thioglycerol solution was prepared every day.

### Example 3

### Investigation of Eluate

Neutralisation of Eluate and Absorbance Measurement

The eluate was collected in test tubes to which 100 μl of neutralisation buffer had been added. The eluate was diluted (1:20) in equilibration buffer. The concentration of the sample solution was determined at 280 nm in a spectrophotometer and calculated according to Lambert Beer's law. The average value of the absorbance was used for concentration determination.

Protein A Leakage

Neutralized eluate was measured by ELISA as described in Steindl F and et al. A simple method to quantify staphylococcal protein A in the presence of human or animal IgG in various samples. J Immunol Meth (2000) 235, 61-9.

Frontal Analysis with Pure Fusion Protein

Frontal analysis was performed according to well known methods. The breakthrough capacity (Q_{B10%}) was calculated according to
Q_{B10%}=(V_{10%}−Vo)Co/Vc
were V_{10%}=applied sample volume at 10% breakthrough, Vo=void volume, Co=sample concentration (mg/ml) and Vc=geometric total volume (ml).

### Results Example 3

A lifetime study using regeneration with 1-thioglycerol was performed for 60 cycles. A selection of chromatograms is presented in FIG. 1. As can be seen, the chromatograms are quite similar, even though the volume of the elution peaks gradually increased. The total peak broadening was about 7% for 40 cycles and 10% for 60 cycles (FIG. 4, triangles). This is a significant improvement compared to the standard protocol (FIG. 4, filled circles).

Results from measurements of host cell protein levels (CHOP) in the elution peaks are shown in FIG. 2. No significant changes could be observed in the CHOP level throughout the study.

The yield was relatively stable (>95%) for 60 cycles. Slightly decreased values were obtained after cycle 37, but no specific trend could be observed (FIG. 3). The lower values occurred directly after change to a new bottle of feedstock, and are probably caused by variation in protein concentration. As a control, frontal analysis with pure fusion protein was performed after 55 cycles. The result revealed that the breakthrough capacity (Q_{B10%}) was unaltered compared to the initial capacity (i.e. 18 mg/ml**) (results not shown).

The column performance in this study, using HR 5/5 columns, was maintained after 55 cycles (table 2).

TABLE 3
Column performance before and after 55 purification cycles.
Packing performance (i.e. plate number and asymmetry) was evaluated
by injection of 100 μl 2% acetone at a flow rate of 0.2 mL/min.

| Column | Asymmetry | Number of theoretical plates |
|---|---|---|
| New | 1.11 | 2367 |
| After 55 cycles | 1.19 | 2668 |

### Example 4

### Comparative Examples

Control Experiment 1: with and without Reducing Regeneration

A control experiment was performed for 26 cycles by use of the same method as above, but without wash with reducing agent (i.e. without reducing regeneration). The result clearly shows that broadening of the elution peaks is much more serious and accelerated (FIG. 4). Thus, 10% peak broadening is obtained already after 15 cycles (compared to 60 cycles of 1-thioglycerol). The total peak broadening after 26 cycles was about 20%.

Control Experiment 2: Protein A Leakage

70 cycles was performed with the same method as above, but human IgG (28 mg/ml) was loaded to the column instead of fusion protein-containing feed. The Protein A leakage was very low (i.e. ≦8 ppm), and no increase in leakage levels could be observed (FIG. 5, table 3).

TABLE 3
Control experiment 2 - Protein A leakage

Protein A leakage

| Cycle no | ng/ml | ppm |
|---|---|---|
| 0 | 0 | 0.0 |
| 1 | 78.9 | 7.1 |
| 2 | 85.15 | 8.0 |
| 4 | 98.65 | 6.7 |
| 5 | 77 | 5.8 |
| 12 | 61.4 | 4.2 |
| 21 | 31.9 | 2.9 |
| 25 | 32.05 | 2.5 |
| 30 | 28.35 | 2.6 |
| 35 | 39.95 | 4.4 |
| 35 | 39.55 | 4.4 |
| 40 | 40.1 | 4.7 |
| 45 | 38.15 | 4.7 |
| 50 | 37.9 | 4.2 |
| 55 | 38.1 | 4.2 |
| 60 | 51.7 | 5.7 |
| 65 | 58.7 | 6.2 |
| 69 | 34.8 | 3.7 |
| 70 | 29.2 | 3.2 |

1. A process of regenerating a separation matrix comprising:
(a) providing a separation matrix from which an adsorbed sample has been eluted;
(b) reducing regeneration by contacting said matrix with a reducing agent;
(c) alkaline regeneration by contacting the matrix with an alkaline solution; and
(d) equilibration of the matrix;
wherein the regeneration steps are carried out in any order of sequence.

2. A process of regenerating a separation matrix comprising:
(a) adsorption of at least one target molecule by contacting a mobile phase comprising a target molecule(s) with a separation matrix;
(b) removal of unbound material by washing the matrix;
(c) elution of target molecule(s) by contacting the matrix with an eluent;
(d) reducing regeneration by contacting said matrix with a reducing agent;
(e) alkaline regeneration by contacting the matrix with an alkaline solution; and
(f) equilibration of the matrix;
wherein the regeneration steps are carried out in any order of sequence.

3. The process of claim 1, further comprising acidic regeneration by contacting the matrix with an acidic solution at any time after elution of adsorbed sample.

4. The process of claim 3, wherein the acidic regeneration is carried out after the reducing regeneration.

5. The process of claim 3, wherein the order of steps after elution is reducing regeneration; acidic regeneration; alkaline regeneration; and equilibration.

6. The process of claim 1, wherein steps (a)-(c) are carried out 1-5 times.

7. The process of claim 1, wherein the separation matrix comprises proteinaceous ligands, which are coupled to a support and which are substantially devoid of disulfide bonds.

8. The process of claim 7, wherein the proteinaceous ligands comprise Protein A

9. The process of claim 1, wherein the separation matrix has been equilibrated with a buffer before the adsorption.

10. The process of claim 2, wherein the washing is carried out by contacting the matrix with a buffer.

11. The process of claim 2, wherein the elution is carried out by adding an eluent comprising a stepwise or continuous pH gradient.

12. The process of claim 1, wherein the reducing regeneration is carried out at alkaline pH.

13. The process of claim 1, wherein the reducing agent comprises one or more thiols.

14. The process of claim 13, wherein the reducing agent comprises thioglycerol.

15. The process of claim 3, wherein the acidic regeneration is carried out at pH below 3.

16. The process of claim 3, wherein the acidic regeneration is carried out with a solution comprising salt.

17. The process of claim 1, wherein the alkaline regeneration is carried out at pH in the range of 10-13.

18. The process of claim 1, wherein the alkaline regeneration is carried out with a solution comprising salt.

19. A separation matrix regenerated according to the method of claim 1.

20. (canceled)

21. A kit for regenerating a separation matrix comprising in separate compartments, at least one reducing agent; at least one alkaline buffer; and written instructions for its use.

22. The kit of claim 21, which comprises at least one acidic buffer.

23. (canceled)

24. A method for isolating at least one target molecule comprising:
(a) adsorption of target molecules by contacting a mobile phase comprising target molecule(s) with a separation matrix;
(b) preferably before the break-through capacity is reached in step (a), removal of unbound material by washing of the matrix;
(c) elution of target molecule(s) by contacting the matrix with an eluent;
(d) after re-equilibration of the matrix; repeating steps (a)-(c);
(e) reducing regeneration by contacting said matrix with a reducing agent;
(f) alkaline regeneration by contacting the matrix with an alkaline solution;
(g) equilibration of the matrix; and, optionally, repeating steps (a)-(f); and
wherein the regeneration steps are carried out in any order of sequence.

25. The method of claim 24, further comprising acidic regeneration by contacting the matrix with an acidic solution at any time after elution but before equilibration of the matrix.

26. The method of claim 24, wherein steps (a)-(c) are repeated 2-5 times.

27-29. (canceled)

30. The process of claim 2, further comprising acidic regeneration by contacting the matrix with an acidic solution at any time after elution but before equilibration of the matrix.
